(19) United States
(12) Patent Application Publication
(10) Pub. No.: US 2012/0144629 A1
(43) Pub. Date: Jun. 14, 2012

(54) CLIP ASSEMBLY WITH A ROTATABLE CLIP

(76) Inventor: Tzu-Chien WANG, Tainan City (TW)

(21) Appl. No.: 13/307,467

(22) Filed: Nov. 30, 2011

(30) Foreign Application Priority Data
Dec. 8, 2010 (TW) 099223766

(51) Int. Cl. F16B 2/20

(52) U.S. Cl. 24/459

(57) ABSTRACT

A clip assembly has a base and a clip. The base includes a hole and multiple pairs of positioning elements. The hole is formed through the base. The pairs of the positioning elements are formed in the base. The clip is rotatably mounted on the base and includes a fastener and two resilient elements. The fastener extends from the clip and is rotatably inserted into the hole of the base. The resilient elements are formed on the clip and selectively engage one pair of the positioning elements of the base. Therefore, the clip can be adjusted to and fixed at a desired position relative to the base such that use of the clip assembly is very practical.

### BACKGROUND OF THE INVENTION

1. Field of the Invention

The present invention relates to a clip assembly, and more particularly to a clip assembly with a rotatable clip that is practical for use.

2. Description of the Prior Arts

A conventional clip assembly comprises a clip secured to a base. The base may be a case or may be mounted on a case. The case is used to store things and the clip is used to clip to an article to hold the stored things in place. However, the clip is not rotatable relative to the base so that the clip assembly may not be practical because of space limitations.

To overcome the shortcomings, the present invention provides a clip assembly with a rotatable clip to mitigate or obviate the aforementioned problems.

### SUMMARY OF THE INVENTION

The main object of the present invention is to provide a clip assembly with a rotatable clip that is practical for use.

To achieve the foregoing objective, the clip assembly in accordance with the present invention comprises a base and a clip. The base includes a hole and multiple pairs of positioning elements. The hole is formed through the base. The pairs of the positioning elements are formed in the base and each pair may be two first locking parts disposed on two sides of the base. The clip is rotatably mounted on the base and includes a fastener and two resilient elements. The fastener extends from the clip and is rotatably inserted into the hole of the base. The resilient elements are formed on the clip, are disposed on two sides of the clip and selectively correspond to one pair of the positioning elements of the base. Each resilient element has a second locking part engaging one of the first locking parts of the corresponding pair of the positioning elements. Therefore, the clip can be adjusted to and fixed at a desired position relative to the base such that use of the clip assembly is very practical.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a clip assembly in accordance with the present invention;

FIG. 2 is a side view of the clip assembly in FIG. 1;

FIG. 3 is a cross-sectional side view of the clip assembly in FIG. 1; and

FIG. 4 is an operational front view of the clip assembly in FIG. 1.

### DETAILED DESCRIPTION OF THE PREFERRED EMBODIMENTS

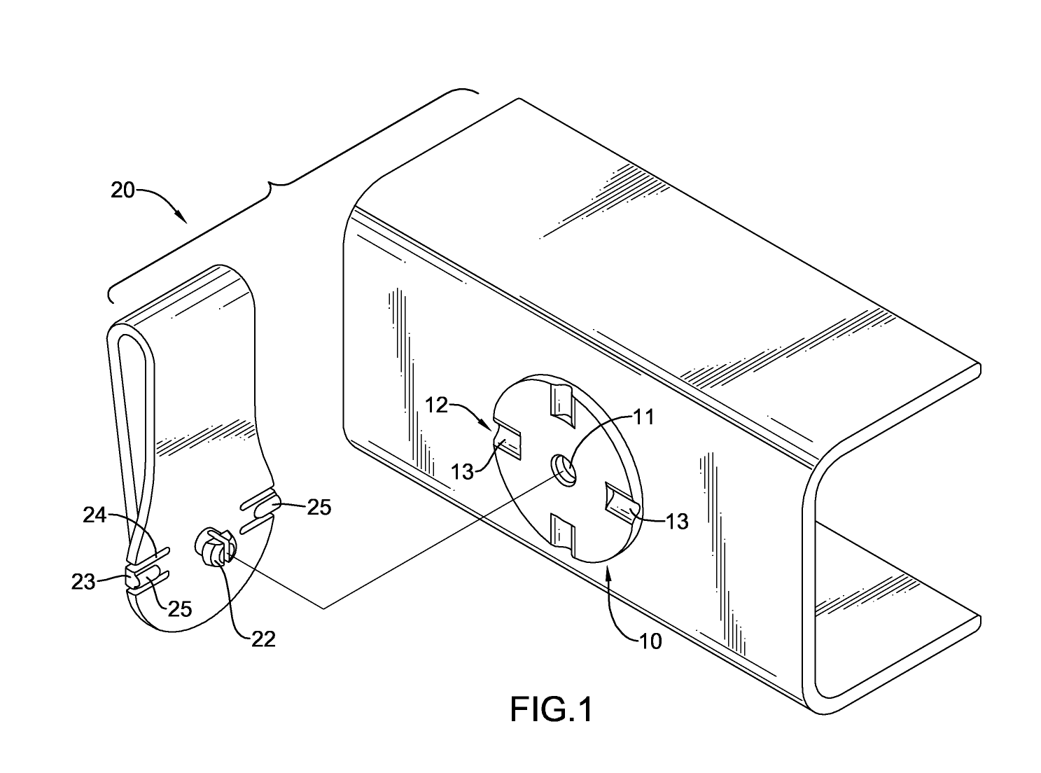

With reference to FIG. 1, a clip assembly in accordance with the present invention comprises a base 10 and a clip 20.

The base 10 includes a front surface, a hole 11 and multiple pairs of positioning elements 12. The hole 11 is formed through the base 10. The pairs of the positioning elements 12 are formed in the front surface of the base 10 and are arranged around the hole 11 of the base 10. Each pair of the positioning elements 12 may be two first locking parts 13 disposed respectively on two sides of the base 10 and locating the hole 11 between the locking parts 13. In a preferred embodiment, the first locking parts 13 are recesses. The base 10 may be a case or may be mounted on a case. For instance, the case is a hand tool box, a glasses case or the like for storing things.

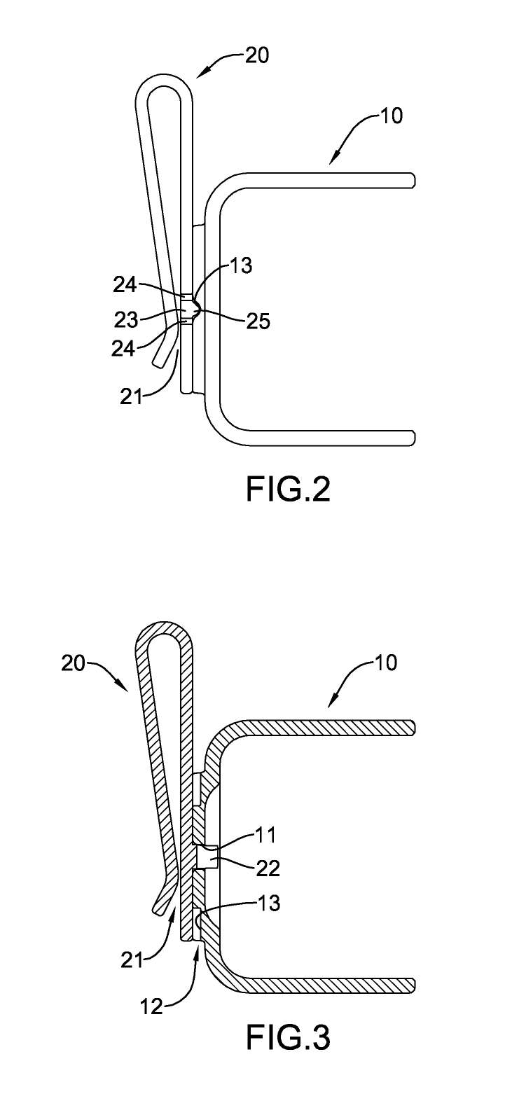

With further reference to FIGS. 2 and 3, the clip 20 is rotatably mounted on the base 10, is bent to form a clip opening 21 for clipping an object and includes a rear surface, a fastener 22 and two resilient elements 23. The fastener 22 extends from the rear surface of the clip 20 and is rotatably inserted into the hole 11 of the base 10. The resilient elements 23 are formed on the clip 20, are disposed respectively on two sides of the clip 20, locate the fastener 22 between the resilient elements 23 and selectively correspond to one pair of the positioning elements 12 of the base 10. Each resilient element 23 has two channels 24 and a second locking part 25. The channels 24 are formed in two edges of the resilient element 23. The second locking part 25 engages one of the first locking parts 13 of the corresponding pair of the positioning elements 12. In the preferred embodiment, the second locking parts 25 are protrusions.

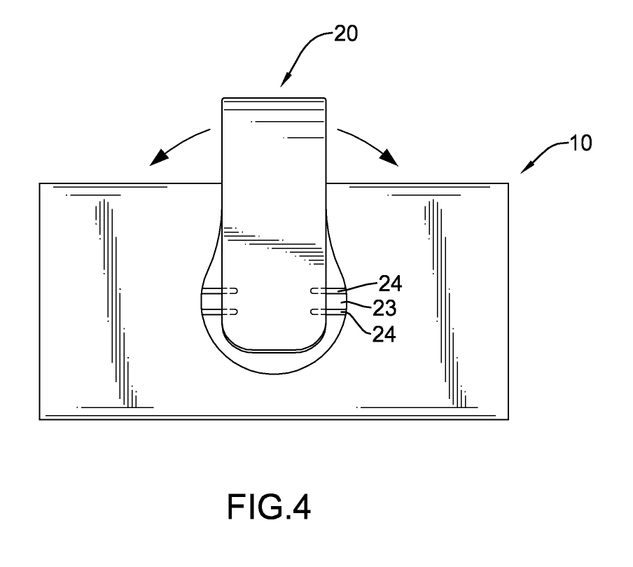

With reference to FIG. 4, the clip 20 can be rotated relative to the base 10 to adjust to a desired position such that use of the clip assembly in accordance with the present invention is very practical. To rotate the clip 20, the resilient elements 23 of the clip 20 are moved to make the second locking parts 25 of the resilient elements 23 disengage from the corresponding first locking parts 13 of the positioning elements 12 of the base 10. The clip 20 can then be rotated to a desired position and be fixed in that position because the second locking parts 25 of the resilient elements 23 engage another corresponding first locking parts 13 of the positioning elements 12 of the base 10. In the preferred embodiment, the base 10 includes two pairs of the positioning elements 12 at an interval. Under this embodiment, the clip 20 can be rotated to fix its position at each 90 degrees.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. A clip assembly comprising:
a base including
a hole formed through the base; and
multiple pairs of positioning elements formed in the base and each pair being two first locking parts disposed on two sides of the base; and
a clip rotatably mounted on the base and including
a fastener extending from the clip and rotatably inserted into the hole of the base; and
two resilient elements formed on the clip, disposed on two sides of the clip and selectively corresponding to one pair of the positioning elements of the base, each resilient element having a second locking part engaging one of the first locking parts of the corresponding pair of the positioning elements.

2. The clip assembly as claimed in claim 1, wherein the first locking parts of the positioning elements of the base are recesses and the second locking parts of the resilient elements of the clip are protrusions.

3. The clip assembly as claimed in claim 1, wherein each resilient element of the clip further has two channels formed in two edges thereof.

4. The clip assembly as claimed in claim 2, wherein each resilient element of the clip further has two channels formed in two edges thereof.

5. The clip assembly as claimed in claim 1, wherein the clip is bent to form a clip opening.

6. The clip assembly as claimed in claim 2, wherein the clip is bent to form a clip opening.

7. The clip assembly as claimed in claim 3, wherein the clip is bent to form a clip opening.

8. The clip assembly as claimed in claim 4, wherein the clip is bent to form a clip opening.
